(19) United States
(12) Patent Application Publication
(10) Pub. No.: US 2010/0122208 A1
(43) Pub. Date: May 13, 2010

(54) Panoramic Mapping Display

(76) Inventors: Adam Herr, Portland, OR (US); David McCutchen, Portland, OR (US); Ben Siroshton, Portland, OR (US)

Correspondence Address: MARGER JOHNSON & MCCOLLOM, P.C., 210 SW MORRISON STREET, SUITE 400, PORTLAND, OR, 97204, US

(21) Appl. No.: 12/188,110

(22) Filed: Aug. 7, 2008

Related U.S. Application Data
(60) Provisional application No. 60/954,552, filed on Aug. 7, 2007.

(51) Int. Cl. G06F 3/048; G01C 21/00

(52) U.S. Cl. 715/799; 715/810; 701/200

(57) ABSTRACT

An interactive software application employs visual confirmation of location information to construct visual routes on a map without the need for separate location-measuring devices. This enables the recording of tours of interiors or other locations where conventional location data such as from a GPS system is unavailable, and the use of even inaccurate or arbitrary maps. The preferred embodiment uses panoramic or immersive motion picture tracks because they contain the most comprehensive amount of information about the location. In drawing the routes of the movies on a floor plan, the user starts with the image of a location to confirm the starting point, then establishes keypoints along the way, locking selected time points of the movies to spatial locations in the map. Other controls change the shape of the routes on the map, or the rate of travel between the keypoints. The result is an interactive, comprehensive tour of a space that can be packaged as an interactive project for distribution locally or as a web service.

### APPLICATION HISTORY

The applicants claim the benefit of provisional application 60/954,552 entitled “Panoramic Mapping Display” filed Aug. 7, 2007.

### BACKGROUND

1. Field of the Invention

This invention generally relates to a panoramic image reproduction system in relation to geographical information systems, and specifically to presentation processing of a document wherein the manner of spatially locating some type of annotation is specified.

2. Description of the Prior Art

Prior attempts to construct maps showing routes representing motion picture sequences of immersive images have relied on GPS information to establish the position of the camera as it moves through the landscape. If the recording takes place indoors or in a location where GPS information is unavailable, there has not been a good alternative for spatially locating the routes on a map.

Attempts have been made to generate indoor location points by establishing alternate methods of measuring and recording the position of the camera. U.S. Pat. No. 7,222,021 by Ootomo, et al for Operator Guidance System, relies on a separate base station transponder that measures the relative position of a mobile station and adjusts a display accordingly.

Individual panoramic stills can be manually located on floor plans in a manner that is accessible over the web, so that the user can click on an individual point and bring up a movable region of interest in the panorama, but complex routes involving thousands of frames of immersive video have not been able to be tied to a map or floor plan in an intuitive manner that allows more comprehensive navigation and searching.

U.S. Pat. No. 6,563,529 by Jongerius for Interactive System for Displaying Detailed View and Direction in Panoramic Images details the use of movable regions of interest within individual panorama locations shown on a map but does not discuss the role of panoramic or immersive video in improving the correspondence with a given map, or the user controls that allow that to happen.

U.S. Pat. No. 7,096,428 by Foote, et al for Systems and Methods for Providing a Spatially Indexed Panoramic Video assumes an accurate spatial database but does not specify how this database can be generated.

U.S. Pat. No. 7,392,208 by Morse, et al for Electronic Property Viewing Method and Computer-Readable Medium for Providing Virtual Tours Via a Public Communications Network describes a web-based search for realty information that can include panoramic photographs of a location, but does not describe the role of immersive video or how photographs can be located in the absence of separately recorded geographic data.

### SUMMARY OF THE INVENTION

A software application with a new user interface enables the improved construction and playback of tours of interiors or exteriors involving routes of panoramic or immersive video or stills, especially in the absence of GPS or any other spatial reference data recorded with the image to give a record of the picture's location. This application is currently being marketed by the Immersive Media Company as OnScene™.

The application contains a simultaneous view of the overall map and of a movable region of interest (ROI) within a chosen panoramic recording, which can include extended motion picture sequences. By use of the appearance of the location in the ROI the user ties key points in the recording to the map, and the application interpolates the remainder of the recording to these key points accordingly.

The application includes extensive controls for manually creating the visual tracks on the map representing the routes, and for managing the flow of time through these visual tracks during playback.

### BRIEF DESCRIPTION OF THE DRAWINGS

FIG. 1 is an example of a floor plan of a site, in this case a shopping mall.

FIG. 2 shows the floor plan inserted into the application and showing a Map View display in part on the left, with a blank Viewer window on the right, with plotted routes and thumbnail alternates

FIG. 3 shows a selection of a location on the map with both the Map cursor and the View cursor.

FIG. 4 shows an alternate scene selected from a thumbnail.

FIG. 5 shows the application's Edit Mode menu.

FIG. 6 shows the pin placement tool in the application.

FIG. 7 shows setting time points for the pins.

FIG. 8 shows locking a pin to the current time using the image in the Viewer Window.

FIG. 9 shows a magnet tool for bending lines.

FIG. 10 shows the project as seen in a browser window

### LISTED PARTS

2 Floor plan

4 Computing environment

6 Preferred embodiment of computer application

8 Map Window

10 Portion of floor plan displayed in Map Window

12 Viewer Window

14 Highlighted current choice of thumbnail

16 White, black, or colored routes

18 Map zoom controls

20 Play control

22 Elapsed time indicator

24 Scroll bar

26 Sound volume control

28 Viewer zoom indicator

30 Viewer Window display

32 Map location cursor

34 Direction of view indicator

36 Directional travel arrow

38 View cursor showing click origin

40 View drag indicator

48 Pan tool

50 Zoom in

52 Zoom out

54 Add a route

56 Remove a route

58 Route Properties

60 Add Pin keypoint

62 Remove Pin

64 Placed pin

66 Route defined by pins

68 New route segment

70 Hand selection cursor

72 Time reference and Set indicator

74 Added pin

76 Magnet

78 Moved magnet

80 Curved line from Magnet

82 Browser window

84 Metadata overlay

### DETAILED DESCRIPTION OF THE INVENTION

The following description of the preferred embodiment and alternative embodiments is not intended to limit the scope of the claims, but only to illustrate the invention so that it may be readily understood by those of ordinary skill in the art as they apply it to their particular problem. What the different embodiments have in common is defined by the claims, and it is the claims, not the embodiments, which define the invention.

In the absence of explicit geographical location data being recorded along with a motion picture, the motion picture visual image itself can be used to construct a track representing the route being followed. Panoramic motion pictures are preferred because they contain the most comprehensive information about the location. The spatial accuracy and completeness of a map or floor plan is not a requirement, because the use of photographic confirmation for a manual route drawing process allows for an effective correspondence to be made to even the most arbitrary map.

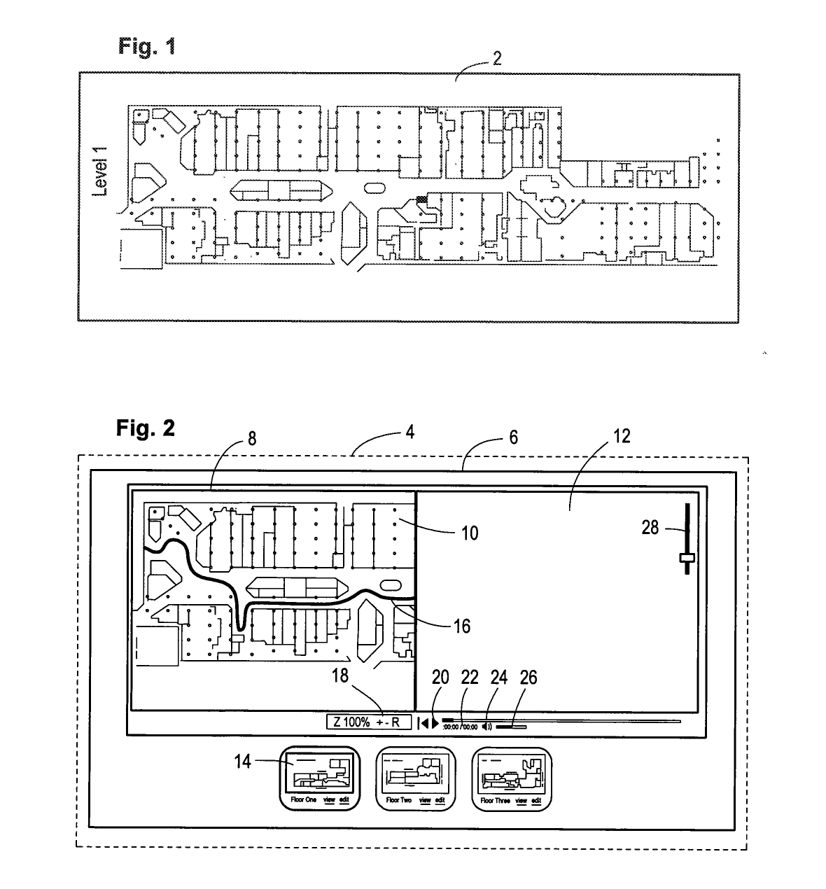

In the preferred embodiment of the graphical user interface application, for mapping an interior, the user can start with a map such as the floor plan 2 shown in FIG. 1 which can be from the design drawings for a building. In many cases, these designs may not match the final as-built structure, so the final map will be improved by a visual confirmation of the elements of the floor plan. This layout can also be a map of an exterior, such as a design drawing or a satellite image. The layout may also consist of imagery that is a ‘subjective’ interpretation of the space it represents rather than a detailed architectural or structurally accurate representation. This feature allows interior spaces to be better described in terms of the relative positions of landmarks rather than with rigorous structural or spatial accuracy.

As shown in FIG. 2, a computing environment 4 comprising a processor contains the preferred embodiment in the form of a graphical user interface application 6, which contains two main windows, the Map Window 8 on the left containing a movable ROI (region of interest) display of a portion of a map of a locality such as the floor plan 10, and the Viewer Window 12 on the right, showing a movable ROI window from within the panoramic or immersive scene. (The term “panoramic” usually refers to an exceptionally wide field of view, up to a 360 wrap-around image, and “immersive” refers to a field of view that is even wider than panoramic, including additional areas up to the top and bottom of the overall spherical field of view. For convenience here, the term “panoramic” can be understood to include both.) If an interior has multiple floors, or there are different areas on an overall map, a thumbnail of each choice is displayed below, with the current choice 14 highlighted.

The floor plan map on the left in FIG. 2 has white, black, or colored travel routes 16 as a graphic overlay, representing the tracks of the digital photographic record, such as immersive video, that have been recorded of the location. The floor plan can be shifted to bring other sections in view with a hand type pan cursor. Zoom controls 18 for this window are also included, in this case with a Reset button to recenter on the portion of the map being displayed in the Viewer Window.

Next to the Viewer Window are playback controls for the frame sequence represented by the route, including a Play control which can include forward and backward speed controls 20, an elapsed time indicator 22 with the second number indicating the length of the overall route segment. There is also a scroll bar 24 showing the overall position in time within the route segment movie, a sound volume control 26 for the movie audio playback, and a zoom indicator 28 for the Viewer Window display 30 to change the field of view. All of these controls in the application can be presented in other forms, and can also be controlled by keyboard shortcuts. The playback controls can also include other options such as or single frame or slow motion forward and reverse, as well as faster forward and reverse speeds.

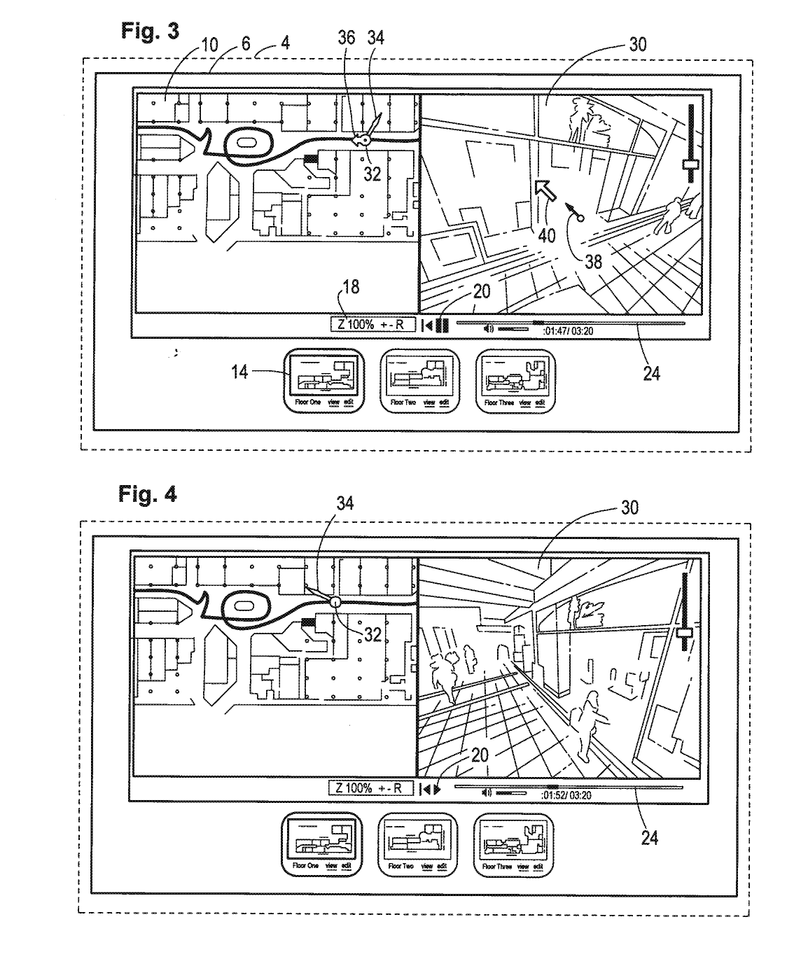

As shown in FIG. 3, selecting a point on any route, such as by pointing and clicking with a mouse, opens a Viewer Window image 30 of the frame at that point within the immersive movie, as indicated on the route in the Map Window with a map location cursor 32, with an indicator of the direction of view in the Viewer Window shown as a direction of view indicator 34 as an addition to the cursor. The Play control 20 advances the movie and the map location cursor moves along the route accordingly, with the direction of motion indicated by an directional travel arrow 36 added to the cursor. At any point, the user is free to look around by clicking and dragging within the ROI window, which will also change the direction of the direction of view indicator 34 in the Map View. This direction of view indicator can be an arrow, a pointer, or a cone indicating the field of view.

A double View cursor indicates the direction and speed of movement of how the user looks around. The point of the initial click is shown as the origin of a black arrow 38, and a white arrow shows the direction and amount of the drag being applied to change the direction of the view 40. Other cursor types may also be used, including simple arrows or crosshairs. After the Play control 20 is selected, it changes its appearance to the Pause mode, as a signal that that can be chosen instead. Clicking the Pause control stops the movie at that point, while still allowing one to look around within the paused frame. The scroll bar 24 allows for navigation back and forth within the route, with the map location cursor also being updated accordingly.

As shown in FIG. 4, pausing the playback changes the map location cursor 32 to a form without a directional travel arrow 36. Changing the direction of view of the display image in the Viewer Window will change the corresponding direction of view indicator 34.

If one route is linked to others, such as when a long route is recorded in multiple sections, the scroll and play functions can be linked to span more than one route. Similarly, if a process of navigation involves branching from one route to another in order to get to a certain point, then the scroll and playback can be linked to this composite route. For example, one may define a start and stop point A and B, and one or more intermediate points to guide a solution through the available travel routes to get from A to B. Then this final composite route solution would form the basis for the playback and scrolling functions.

Selecting another floor or region from the included thumbnails or list of choices brings up a similar map of another place with it associated route information for navigation.

### Edit Mode

The default User mode allows the used to select any spot to see and navigate. Selecting the Edit mode allows the route components to be seen and changed with an additional set of edit controls 42. However, these changes are not saved in the final distributed version, unless a link is provided to publish and update the source xml that generates the map, the routes over it, and the immersive movies linked to those routes.

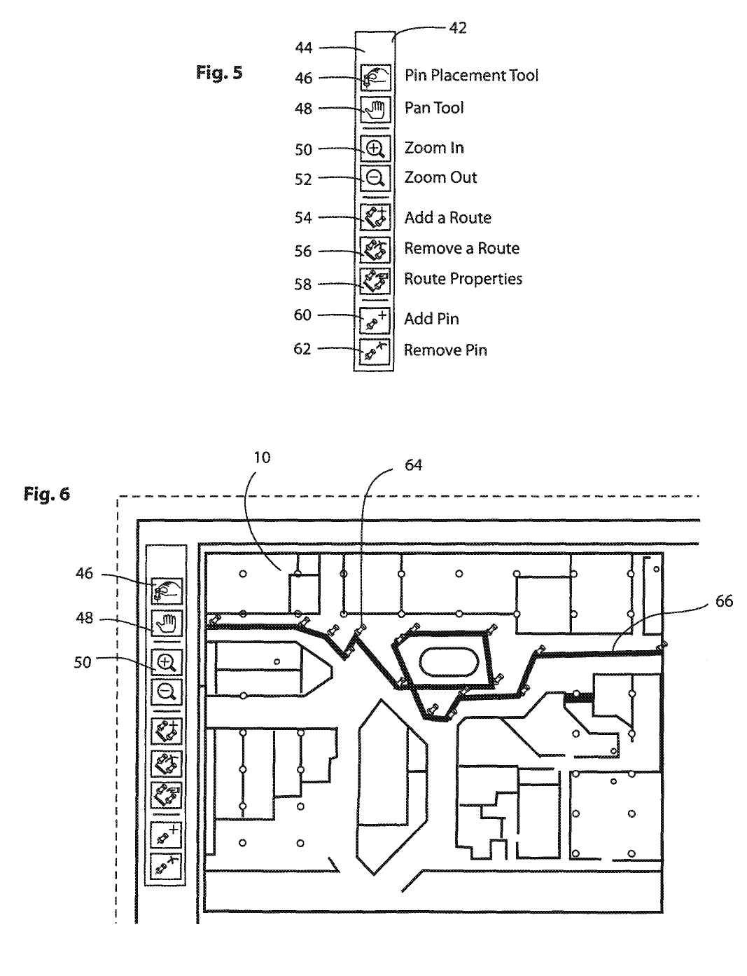

As shown in detail in FIG. 5, the controls indicated by icons are, from the top below the Immersive Media logo 44, the Pin Placement tool 46, Pan tool 48, Zoom In on the map 50, Zoom Out on the map 52, Add a Route 54, Remove a Route 56, Route Properties 58, Add Pin 60, and Remove Pin 62.

The main control points for configuring routes are represented by pins, as shown in FIG. 6. The Pin Placement tool 46 is used to place pins 64 in the route 66 to mark the control points where the frame of the immersive movie can be set to correspond to a point on the map. This allows the user to match the spatial representation on the map with the time scale represented by the running frames of the movie. The map or floor plan 10 can be moved around and resized using the Pan tool 48 and Zoom tool 50 to show the portion represented by the route.

Edit mode is used to build and change the appearance of projects, which are collections of data about a particular location, made available through this application by using links to the appropriate resources. These links can be to local or online resources, with access controlled according to the user or the creator's requirements. Typically, in edit mode, links to one or more maps are added first. Then when a new route segment 68 is added with the Add Route tool 54, it first is created as a straight line, with a link with the name of a movie that will correspond to it. This name and link can be seen using Route Properties 58. The line can also be given a distinctive color and width. The default is for the line to be created with two movable pins, corresponding to the start and end. Adding and moving pins along the line allows it to be shaped to correspond to a desired route in a rubber band fashion, and also to set points of correspondence in time with the source movie.

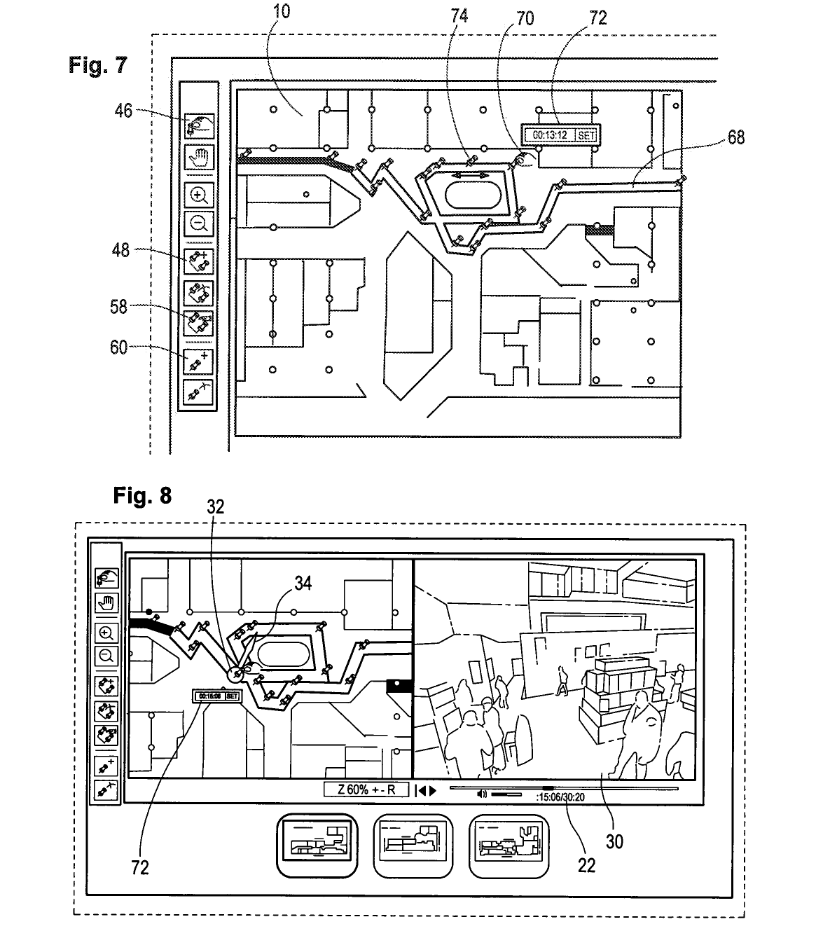

As shown in FIG. 7, if a pin is selected, as shown by the hand selection cursor 70, a time reference 72 shows where it is assumed to correspond to in the source movie. If a change is desired, the movie is played forward to display the proper point of correspondence in the location, and hitting “Set” locks this displayed video frame and time to the line at that point, and interpolates appropriately to the pin keypoints on either side.

For example, a route goes along a hallway and passes a door. During the recording, the speed of movement was much slower along the hallway after the door than before it. When a line was created for the route, it would assume that the speed was constant. When a pin keypoint such as 74 was added with the Add Pin tool 60, it would fall midway on the line, and then it could be slid along the line to correspond to a feature on the floor plan, such as next to the door. Then the movie is played or scrolled forward until the same point is reached in the video, where the camera is next to the door, and hitting “Set” in the pin's time reference 72 locks the pin and the movie together. So if the point of correspondence was midway along the route, but only a third of the way into the movie, then the map location cursor would move along the route line faster up to the midway pin, then slower after it. Adding more and more pins allows finer and finer control of the shape of the route and the movie frames that correspond to it.

Using the View Window, as shown in FIG. 8, serves as confirmation of the current position of the movie frame on the map, with the viewer free to look around in any direction, when using a panoramic image, to find the characteristic landmarks. In this way, an effective correspondence can be established between even the most arbitrary map and the photographic record of movement through the actual place. Here the viewer image 30 displays the frame indicated by the time indicators both for a selected pin 72 and for the View Window 22, with a direction of view indicator 34 and a map location cursor 32.

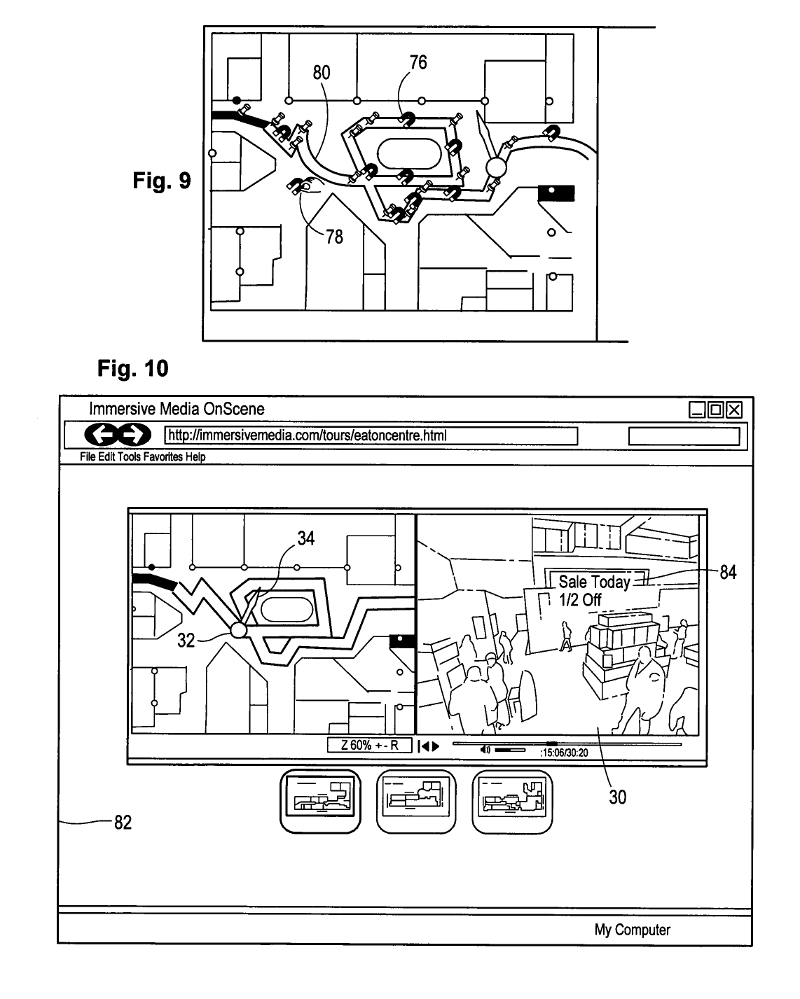

For routes that involve more than straight-line segments, a magnet tool can be used to add spline curves to the routes, as shown in FIG. 9. This is best done as a finishing step, after the pins have been located. A command, such as Control-M, turns on the display of the magnets 76, which are located midway between the pins. Pulling the magnets away from the route line causes a segment to bend, while the ends remain anchored on the pins. This approach avoid the visual clutter and overlap of multiple spline handles extending from the pins themselves.

Associated metadata can be presented in the application along with any selected panoramic images from a route. For example, an overlay of information about special offers could be associated with the image of a store as it appears in the Viewer window. This information would be associated in the database with a range of frames in the movie, and, if the overlay is to be superimposed on the image, the exact direction for every frame to a target point within the panoramic image. A comparison to the current date in the computer can serve to enable or disable this special feature. An overlay can also be added to the map window to show such special information.

Currently immersive movies, at a frame rate up to 30 frames per second and suitable for the present invention, are being produced by the Immersive Media Company. These movies are available in a variety of resolutions, frame rates, and compression methods depending on the bandwidth restrictions of the final presentation, and the storage limitations of the overall project.

The project can be converted to an XML string that includes the appropriate paths to the source material, including the movies, maps and metadata. The XML that constitutes a project can be easily stored in a database via a suitable web service. The content used by a project can be a mix of Internet and local network resources, such as when the immersive source movies are too large to be delivered by an Internet connection, but the background map and the routes can be. So the movies can be available on a high-bandwidth local connection such as from a disk or hard disk, while accessing the overall map through a browser, as shown in FIG. 10. Middle-tier technologies can be leveraged, in conjunction with the project database, to create dynamic immersive mapping solutions over the web.

This approach can be applied to the construction of exterior as well as interior projects, or a mix of the two. It does not depend upon GPS information to make a location for the image, but can make use of visual confirmation of location, made especially accurate because it makes use of an immersive image which can look in every direction as needed. Because of this, it can make an effective correspondence between a comprehensive photographic recording and an arbitrary or stylized map.

The applicants claim:

1. A graphical user interface rendered on a display screen, comprising
(1) a map window displaying a graphic representation of a locality, with
an interactive graphic overlay on a map of a locality, the graphic overlay representing a travel route along which plural frames of a photographic sequence are obtained of the locality and including frame locators corresponding to the frames of the photographic sequence,
a route location indicator representing a selected frame locator and a direction of travel to a subsequent frame in said photographic sequence according to a given direction of travel along the travel route, and
a view direction indicator indicating a direction of view within the selected frame;
(2) a view window displaying a view of the selected frame corresponding to the direction of view indicated by the view direction indicator; and
(3) a user-operable playback controller for controlling playback of the photographic sequence.

2. The graphical user interface of claim 1, wherein a selection can be made by the user of a point on the graphical overlay in order to specify a frame locator to a selected frame at a selected location, said selection producing an indicator on said graphic overlay at said point, with a view of the selected frame being displayed in the view window.

3. The graphical user interface of claim 1, wherein said view of the selected frame comprises a movable region of interest represented by said direction of view indicated by the view direction indicator.

4. The graphical user interface of claim 1, wherein said playback controller produces temporal movement within said photographic sequence, wherein movement in time in said photographic sequence changes the displayed frames in the view window and their representative indications in the map view.

5. The graphical user interface of claim 1 in which the images displayed in the view window are regions of interest of a panoramic image recording.

6. The graphical user interface of claim 4 in which the plural successive images are still images.

7. The graphical user interface of claim 4 in which the plural successive images are video images.

8. The graphical user interface of claim 1, wherein the map, the graphic overlay and the photographic sequence may be stored separately at local or online resource locations.

9. The graphical user interface of claim 1, wherein one or more additional graphic overlays are added to the map window or the view window according to the frame being displayed.

10. A graphical user interface rendered on a display screen, comprising
(1) a map window displaying a graphic representation of a locality, with
an interactive graphic overlay on a map of a locality, the graphic overlay representing a travel route along which plural frames of a photographic sequence are obtained of the locality and including frame locators corresponding to the frames of the photographic sequence,
plural user-positionable travel route keypoints indicating a start, an end, and at least one intermediate point of the travel route, the travel route conforming to the locations of the travel route keypoints and the frame locators being distributed between each adjacent pair of travel route keypoints, and
a view direction indicator indicating a direction of view within the selected frame;
(2) a view window displaying a view of the selected frame corresponding to the direction of view indicated by the view direction indicator; and
(3) a user-operable playback controller for controlling playback of the photographic sequence.

11. The graphical user interface of claim 10, wherein the travel route keypoints control the shape of said graphic overlay in a rubber band fashion.

12. The graphical user interface of claim 11, wherein spline control varies the graphic overlay between the travel route keypoints.

13. The graphical user interface of claim 10, wherein selected frames of the photographic sequence are linked to selected travel route keypoints.

14. The graphical user interface of claim 10, wherein the frame locators are distributed evenly between each adjacent pair of travel route keypoints.
